(19) United States
(12) Patent Application Publication
(10) Pub. No.: US 2018/0056436 A1
(43) Pub. Date: Mar. 1, 2018

(54) SYSTEMS, METHODS, AND DEVICES FOR EXIT HOLE REPAIR ASSOCIATED WITH WELDING OPERATIONS

(71) Applicant: The Boeing Company, Chicago, IL (US)

(72) Inventors: Eric E. Thomas, St. Charles, MO (US); Sean M. Thuston, High Ridge, MO (US); Brian J. Martinek, Troy, MO (US); John A. Baumann, St. Charles, MO (US)

(73) Assignee: The Boeing Company, Chicago, IL (US)

(21) Appl. No.: 15/247,967

(22) Filed: Aug. 26, 2016

(51) Int. Cl. B23K 20/12

(52) U.S. Cl. CPC B23K 20/122; B23K 2201/006

(57) ABSTRACT

Systems, methods, and devices are disclosed herein that repair and fill exit holes created by welding operations on vehicle components or parts. Methods may include inserting a plug into the exit hole in one or more vehicle parts, where the exit hole is created by the welding operation performed on the one or more vehicle parts. Methods may further include positioning a first pin on the plug such that the first pin is contacting an exposed surface of the plug, and rotating the first pin while contacting the exposed surface of the plug, where the rotating generates thermal energy based on a frictional force associated with the first pin and the plug. The methods may also include filling the exit hole by heating and plasticizing the plug via the thermal energy, and consolidating a material of the plug with the one or more vehicle parts.

### TECHNICAL FIELD

This disclosure generally relates to vehicles and machinery and, more specifically, to exit hole repair associated with portions of such vehicles.

### BACKGROUND

During manufacturing of various types of vehicles, such as aircraft, spacecraft, and other motor vehicles, various welding techniques may be used to provide structural reinforcement amongst parts at joints between different vehicle parts, thus joining them together. In one example, a welding technique such as friction stir welding may be implemented. In such a technique, the weld tool may progress along a seam of a joint, and may create a weld zone as it goes. Upon reaching the termination of the joint and the end of the weld, the welding tool may be removed from the joint of the vehicle parts. However, the removal of the welding tool results in an exit hole that is a hole, indentation, or deformation in the surface of the vehicle parts and their weld. Accordingly, such welding techniques are limited because they result in surface irregularities, such as exit holes.

### SUMMARY

Disclosed herein are systems, methods, and devices that may be used to repair and fill exit holes that may have been created by various welding operations associated with vehicle components or parts. Methods may include inserting a plug into the exit hole in one or more vehicle parts, where the exit hole is created by the welding operation performed on the one or more vehicle parts. Methods may further include positioning a first pin on the plug such that the first pin is contacting an exposed surface of the plug, and rotating the first pin while contacting the exposed surface of the plug, where the rotating generates thermal energy based on a frictional force associated with the first pin and the plug. The methods may also include filling the exit hole by heating and plasticizing the plug via the thermal energy, and consolidating a material of the plug with the one or more vehicle parts.

In some embodiments, the first pin is positioned approximately normal to the exposed surface of the plug. In various embodiments, the exposed surface of the plug is an upper surface of the plug. The methods may also include applying pressure to the exposed surface of the plug via the first pin, plasticizing the material of the plug via the thermal energy, extending, while rotating, the first pin into the exit hole, mixing the material of the plug, and retracting the first pin from the exit hole. In some embodiments, the plug is consumed by consolidation with the one or more vehicle parts. In various embodiments, the exit hole is created by a friction stir welding operation performed on a portion of a joint. According to some embodiments, the joint is a butt joint between a first vehicle part and a second vehicle part. In various embodiments, the friction stir welding operation is performed using a second pin. In some embodiments, the second pin has a different diameter than the first pin. In various embodiments, the second pin has a smaller diameter than the first pin.

Also disclosed herein are devices for filling an exit hole created by a welding operation. The devices may include a containment collar configured to contact a plurality of surfaces of a plurality of vehicle parts associated with the welding operation, and further configured to form a seal around the exit hole. The devices may also include a pin configured to be positioned on a plug inserted in the exit hole, and further configured to be rotated while in contact with an exposed surface of the plug. The devices may further include a shoulder member configured to facilitate a movement of a material of the plug during an extension of the pin.

In various embodiments, the pin is configured to be retractable in a first direction and extendable in a second direction, and the pin is further configured to apply pressure to the exposed surface of the plug while the pin is rotating. In some embodiments, the rotating generates thermal energy based on a frictional force associated with the pin and the plug. In various embodiments, the heating of the plug via the thermal energy and plasticizing causes consolidation of a material of the plug with the plurality of vehicle parts and further causes the filling of the exit hole. According to some embodiments, the shoulder member is configured to be retractable in the first direction and extendable in the second direction, the shoulder member is configured to generate a cavity into which at least some of the material of the plug enters when the shoulder member is retracted in the first direction, and the shoulder member is configured to apply an amount of pressure to the material of the plug when extended in the second direction.

Also disclosed herein are systems for filling an exit hole created by a welding operation. The systems may include at least one spindle configured to generate a rotational force and a repair tool. The repair tool may include a containment collar configured to contact a plurality of surfaces of the plurality of vehicle parts, and further configured to form a seal around the exit hole. The repair tool may also include a first pin configured to be positioned on a plug inserted in the exit hole, and further configured to be rotated while in contact with an exposed surface of the plug. The repair tool may additionally include a shoulder member configured to facilitate a movement of a material of the plug during an extension of the first pin.

In some embodiments, the first pin is configured to be retractable in a first direction and extendable in a second direction, the first pin is further configured to apply pressure to the exposed surface of the plug while the first pin is rotating, the rotating generates thermal energy based on a frictional force associated with the first pin and the plug, and heating of the plug via the thermal energy and plastic deformation causes consolidation of a material of the plug with the plurality of vehicle parts and further causes the filling of the exit hole. In various embodiments, the shoulder member is configured to be retractable in the first direction and extendable in the second direction, the shoulder member is configured to generate a cavity into which at least some of the material of the plug enters when the shoulder member is retracted in the first direction, and the shoulder member is configured to apply an amount of pressure to the material of the plug when extended in the second direction. In various embodiments, the welding tool includes a second pin configured to be rotated, and further configured to friction stir weld the joint associated with a plurality of vehicle parts. In some embodiments, the second pin has a smaller diameter than the first pin.

### BRIEF DESCRIPTION OF THE DRAWINGS

FIG. 1 illustrates cross-sectional view of an example of a repair tool, configured in accordance with some embodiments.

FIG. 2 illustrates cross-sectional view of an example of a repair tool implemented in a repair system, according to some embodiments.

FIG. 3 illustrates a flow chart of a method for repairing an exit hole, implemented in accordance with some embodiments.

FIG. 4 illustrates a flow chart of another method for repairing an exit hole, implemented in accordance with some embodiments.

FIGS. 5A-5C illustrate cross-sectional views of a plug being inserted into an exit hole, implemented in accordance with some embodiments.

FIGS. 6A-6E illustrate cross-sectional views of an exit hole being repaired, implemented in accordance with some embodiments.

FIG. 7 illustrates an example of an external view of a repair tool, configured in accordance with some embodiments.

FIG. 8 illustrates a data processing system configured in accordance with some embodiments.

FIG. 9 illustrates a flow chart of an example of an airplane production and service methodology, in accordance with some embodiments.

FIG. 10 illustrates a block diagram of an example of an airplane, in accordance with some embodiments.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as to not unnecessarily obscure the described concepts. While some concepts will be described in conjunction with the specific examples, it will be understood that these examples are not intended to be limiting.

In various embodiments, welding techniques may result in surface irregularities such as exit holes. For example, a friction stir welding technique may utilize a spinning or rotating stir pin and heat generated by frictional forces to mix together and weld material from different vehicle parts along a particular joint that is being welded. However, when the stir pin is retracted, an indentation or hole may be left behind on the surface of the vehicle parts at the end of the weld. Such surface imperfections may be undesirable in the context of manufacturing vehicles such as aircraft and spacecraft.

Accordingly, various devices, systems and methods are disclosed herein that repair exit holes created by various welding techniques. For example, repair tools and systems are disclosed herein that insert a plug into the exit hole, and position a rotatable pin on the inserted plug. The pin may then be rotated to heat the material of the plug, and to enable consumption of the entire plug and consolidation of the material of the plug with the materials of the vehicle parts that were welded. Moreover, as discussed in greater detail below, other components, such as a containment collar and shoulder member, may also be implemented to facilitate the process and ensure that the entire plug is consumed and consolidated. Accordingly, as will be discussed in greater detail below, such repair tools and systems may efficiently, effectively, and programmably fill and repair exit holes left in welds.

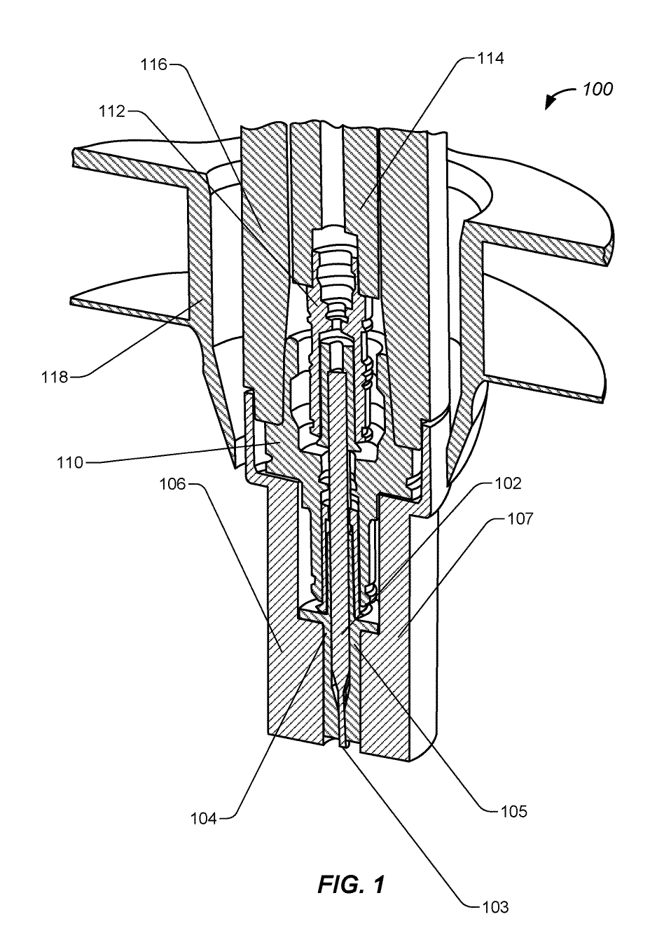

FIG. 1 illustrates a cross-sectional view of an example of a repair tool, configured in accordance with some embodiments. As will be discussed in greater detail below, a repair tool, such as a repair tool 100, may be configured to use a plug to repair a hole that has been made by one or more welding operations, as may occur during a friction stir welding process. Moreover, as will also be discussed in greater detail below, the repair tool 100 may also be configured to implement the one or more welding operations. Thus, in one configuration the repair tool 100 may be configured to perform welding operations included in a friction stir welding process, and in another configuration the repair tool 100 may be configured to repair one or more exit holes created by the welding operations.

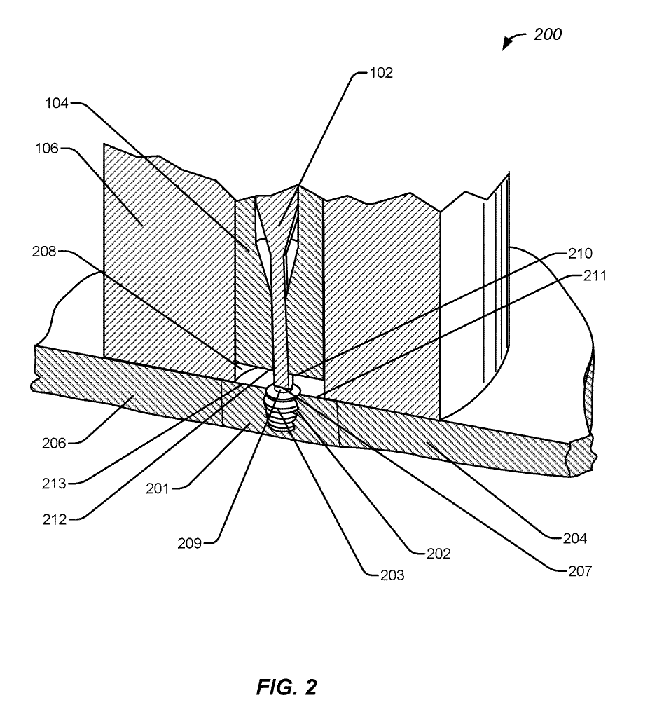

According to some embodiments, the repair tool 100 includes a pin 102. As will be discussed in greater detail below with respect to FIG. 2, the pin 102 is coupled to a first spindle, such as a first spindle 114, that is configured to rotate the pin 102 in either a clockwise or counter-clockwise direction. Such coupling may be achieved via a first coupling portion 112. In various embodiments, the pin 102 is made of a material which may be configured to endure repeated generation of heat via frictional forces. For example, the pin 102 may be made of metal. Moreover, in some embodiments, the pin 102 is configured to have a surface geometry, which may be a surface 103, that is configured to match or mate with an exposed surface of a repair plug, as will be discussed in greater detail below with reference to FIG. 2. Accordingly, the pin 102 may have a surface geometry configured to increase a frictional coefficient between the pin 102 and the plug by increasing a surface area of a region of contact between the pin 102 and the plug when the pin 102 is placed on the plug.

In various embodiments, the repair tool 100 is moveable so that it may be dynamically positioned to change an orientation and position of the pin 102. Accordingly, the repair tool 100 is configured to position the pin 102 on a repair plug utilized in the repair operations. As will be discussed in greater detail below, the pin 102 may be positioned normal to an exposed surface of the plug such that a centerline of the pin 102 is aligned with a center line of the plug, and the pin 102 is capable of directly contacting the plug. Accordingly, the repair tool 100 is configured to position the pin 102 on the repair plug, rotate the pin 102 to generate thermal energy via frictional forces, and enable the consumption and consolidation of the plug, as well as some portion of the surrounding material, will be discussed in greater detail below.

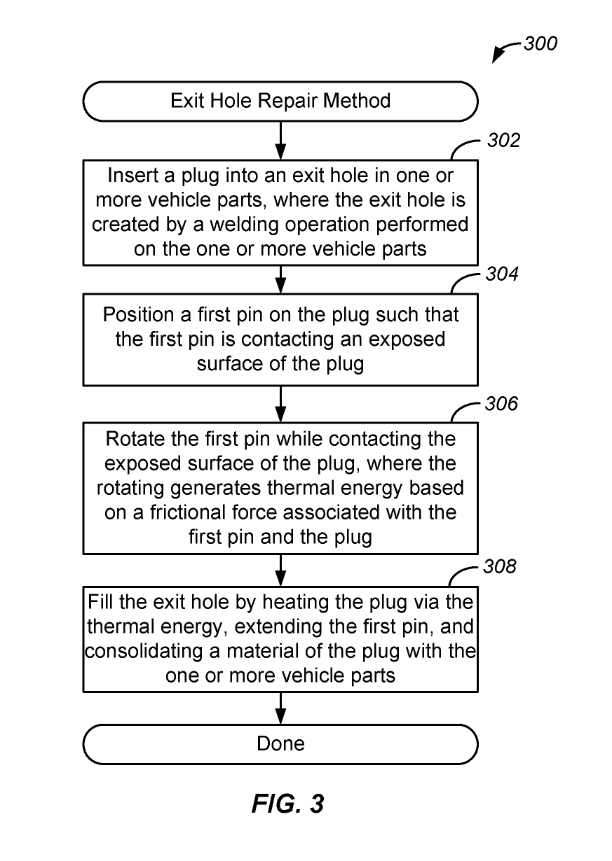

The repair tool 100 also includes a shoulder member 104 which is configured to facilitate the positioning and movement of the? material of the plug during repair operations, as will be discussed in greater detail below with respect to FIGS. 3, 4, and 6A-6E. Accordingly, the shoulder member 104 may be independently movable from the pin 102, and may be retractable and extendable in first and second directions that are parallel to the centerline of the pin 102. Such movement of the shoulder member 104 may be controlled by a second spindle, such as a second spindle 116, which may be coupled to the shoulder member 104 via a second coupling portion 110. In various embodiments, the shoulder member 104 is configured to retract in the first direction to create or generate a cavity or void into which displaced plug material may enter when forced out of an exit hole that is being repaired by, for example, the pin 102. In various embodiments, the shoulder member 104 is further configured to extend in the second direction to facilitate the movement of the plug material back into the exit hole. In some embodiments, the shoulder member 104 is configured to apply an amount of pressure to the displaced plug material to facilitate such movement back into the exit hole. Thus, according to various embodiments, the retraction and extension of the shoulder member 104 is configured to maintain an amount of pressure on the plasticized plug material to ensure that the plasticized condition is maintained and contained.

As will be discussed in greater detail below, such stirring, mixing, plasticizing, and softening of material enables the pin 102 to be pushed further into the exit hole and consolidate all of the plug material as it is pushed, as opposed to just plasticizing the top or exposed surface of the plug. In this way, adjustment of the position of the shoulder member 104 may facilitate the consumption and consolidation of the entire plug and surrounding material as opposed to just a portion, and further increase the effectiveness of the repair operations. In some embodiments, the shoulder member 104 has a hollow cylindrical shape. As stated above, FIG. 1 is a cross-sectional view of the repair tool 100. Accordingly, a portion 105 may be the cross-sectional representation of the other side of the shoulder member 104.

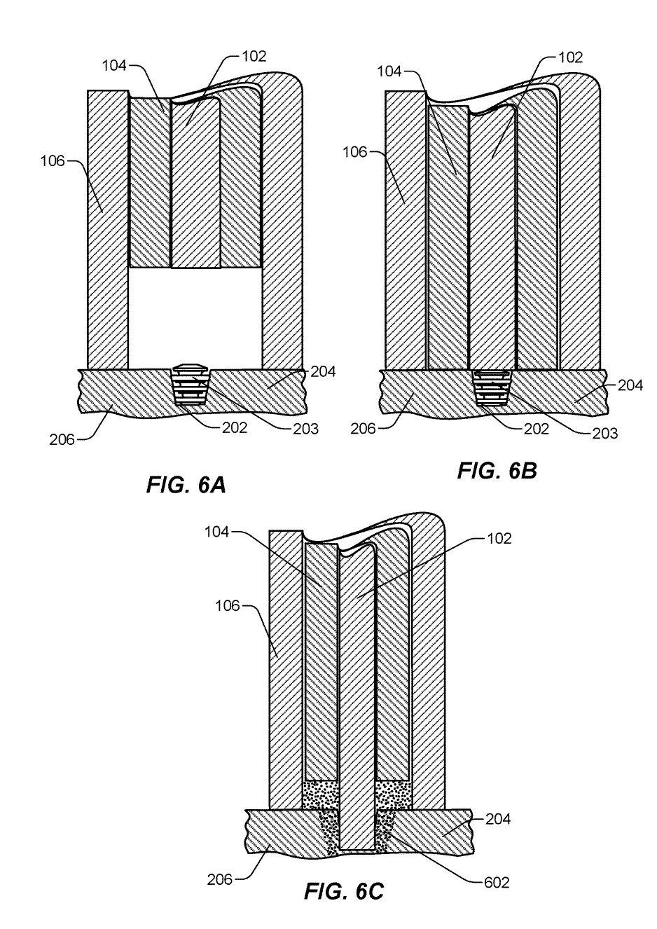

The repair tool 100 further includes a containment collar 106 which is configured to contain plug material within a designated area. Accordingly, once positioned in place such that the containment collar 106 bounds a designated area that includes an exit hole being repaired, the containment collar 106 is configured to provide a physical barrier that retains plug and parent material (which may come from parts) so they can be returned to the area inside the workpiece or part(s). In some embodiments, the containment collar 106 is also configured to be movable in the first and second directions, is configured to be extended in the second direction at the beginning of repair operations until it contacts an exposed surface of the components being repaired, and is further configured to be retracted in the first direction at the termination of repair operations. In various embodiments, the containment collar 106 is not independently moveable and is mounted to the repair tool 100 via a fixed mount. In some embodiments, the containment collar 106 has a hollow cylindrical shape. Moreover, while FIG. 1 and FIG. 2 discussed in greater detail below illustrate one example of a size and shape of the containment collar 106 and the shoulder member 104, geometries, shapes, and proportions of the containment collar 106 and the shoulder member 104 may be configured in various ways. For example, as will be discussed in greater detail below with reference to FIG. 6A-6E, the containment collar 106 and the shoulder member 104 may be configured such that there is little to no space between the containment collar 106 and the shoulder member 104

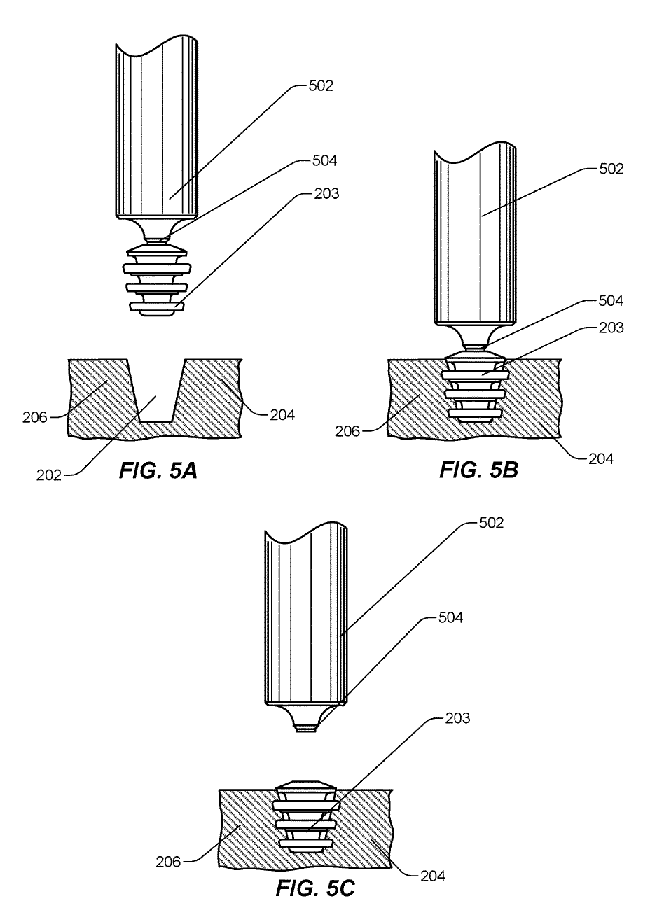

In various embodiments, a support member, such as a support member 118, may be utilized to provide stability and structural support for components of the repair tool 100, as well as facilitate movement of components of the repair tool 100 relative to vehicle components and parts. Moreover, the movement of various components of the repair tool 100, such as the pin 102 and the shoulder member 104 via the first spindle 114 and the second spindle 116 as well as positioning of the repair tool 100 by at least the support member 118, which may be mounted on or part of a movable support stage, may be controlled by a computer system or data processing system, such as a data processing system 800 described in greater detail below. As stated above, FIG. 1 is a cross-sectional view of the repair tool 100. Accordingly, the portion 107 may be the cross-sectional representation of the other side of the containment collar 106. As will be described in greater detail below, in some embodiments, the containment collar 106 may be removably coupled to the repair tool 100, and may be detached or uncoupled if the repair tool 100 is implementing other operations, such as installation of a repair plug, as discussed below with reference to FIGS. 5A-5C.

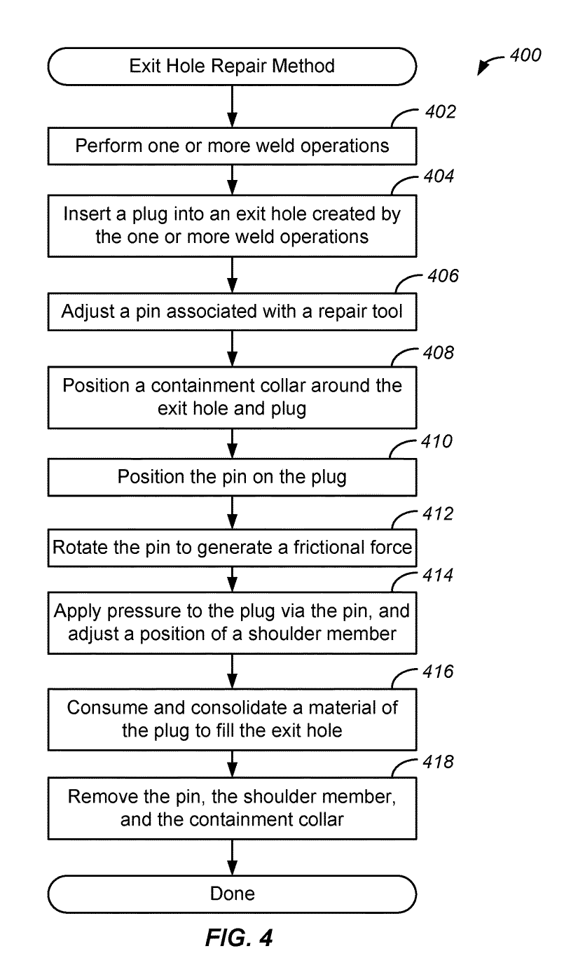

FIG. 2 illustrates cross-sectional view of an example of a repair tool implemented in a repair system, according to some embodiments. Accordingly, a repair system, such as a repair system 200, may include the repair tool 100 as well as its components, such as the pin 102, the shoulder member 104, and the containment collar 106. As similarly discussed above, the repair system 200 is configured to repair exit holes that have been created by welding operations in which parts or components of a vehicle have been welded together. As shown in FIG. 2, a first vehicle part 204 and a second vehicle part 206 have been welded together in a butt joint configuration, and weld area, region, or a zone 201 as well as an exit hole 202 have been created as a result of the welding operations which may have included the retraction of a tool at the completion of a friction stir weld. While FIG. 2 illustrates an example of a butt joint, other types of joints and configurations may be used with any of the embodiments disclosed herein, such as lap welds. Furthermore, a plug 203 has already been inserted in the exit hole 202. Additional details regarding the insertion of the plug 203 will be discussed in greater detail below with respect to FIGS. 4 and 5A-5C.

As shown in FIG. 2, the containment collar 106 has already been positioned on the welded vehicle parts and around the exit hole such that any plug material from the plug 203 that is plasticized during repair operations will be contained within the area, such as an area 208, bounded by the containment collar 106. As further shown in FIG. 2, the pin 102 and the shoulder member 104 have not yet been positioned on the plug 203 and the vehicle parts 204 and 206, respectively. As will be further described with reference to FIGS. 3, 4, and 6A-6E, the pin 102 is configured to be extended such that the surface 207 of the pin 102 contacts an exposed surface, such as the surface 209 of the plug 203 which may be an upper surface of the plug 203. Moreover, the shoulder member 104 is configured to be extended such that the surface 210 of the shoulder member 104 contacts the surface 211 of the vehicle part 204, and the surface 212 of the shoulder member 104 contacts the surface 213 of the vehicle part 206. Additional details regarding the operation of the repair tool 100, the repair system 200, and the repair of the exit hole 202 are discussed in greater detail below. As similarly discussed above, in some embodiments, the containment collar 106 may be removably coupled to the repair tool 100, and may be detached or uncoupled if the repair tool 100 is implementing other operations, such as installation of a repair plug, as discussed below with reference to FIGS. 5A-5C.

FIG. 3 illustrates a flow chart of a method for repairing an exit hole, implemented in accordance with some embodiments. As discussed above, material of a repair plug may be used to fill an exit hole in welded vehicle components that has been left by welding operations. Accordingly, method 300 may commence with operation 302 during which a plug may be inserted into the exit hole. In various embodiments, the plug may be inserted by a repair tool, such as the repair tool 100, which may be configured to hold the plug until the plug is positioned within the exit hole. The repair tool is further configured to release the plug once the plug has been positioned securely in the exit hole, as will be discussed in greater detail below with reference to FIGS. 5A-5C. In some embodiments, the inserting of the plug may be performed by a separate tool other than the repair tool 100.

Method 300 may proceed to operation 304 during which a first pin may be positioned on the plug such that the first pin is contacting an exposed surface of the plug. In various embodiments, the first pin is the pin 102 discussed above. Accordingly, the first pin may be positioned such that it contacts an exposed surface of the plug, such as the surface 209 discussed above. As previously discussed, and as discussed in greater detail below, a containment collar may be positioned around the exit hole prior to the positioning of the first pin.

Method 300 may proceed to operation 306 during which the first pin is rotated while contacting the exposed surface of the plug. Accordingly, a spindle of the repair tool may generate a rotational force and transfer the rotational force to the first pin, thus causing it to rotate while in contact with the plug. In various embodiments, the rotating generates thermal energy based on a frictional force associated with the first pin and the plug. Accordingly, friction between the surface of the first pin and the surface of the plug may generate heat which may cause the material of the plug to heat up.

Accordingly, method 300 may proceed to operation 308 during which the exit hole may be filled by the heating of the plug via the thermal energy and extending the first pin into the exit hole. Thus, the heat generated during operation 306 may cause the material of the plug to plasticize and enter a state in which the material of the plug may penetrate all contours and crevices of the exit hole. Moreover, the first pin may be extended into the exit hole (as will be discussed in greater detail below), to facilitate mixing of the material of the plug. Accordingly, as a result of the heating process, the rotation of the first pin, the extension of the first pin into the exit hole, and the subsequent cooling off the materials involved, the material of the plug may consolidate with the material of the one or more parts that were previously welded, thus robustly filling the exit hole.

FIG. 4 illustrates a flow chart of another method for repairing an exit hole, implemented in accordance with some embodiments. As discussed above, an exit hole may be created by welding operations, such as friction stir welding operations. Furthermore, material of a repair plug may be used to fill an exit hole in welded vehicle components that has been left by the welding operations. Accordingly, the creation of the exit hole and its repair may be part of the same manufacturing method.

In various embodiments, method 400 may commence with operation 402 during which one or more weld operations may be performed. As discussed above, the weld operations may be those associated with a friction stir weld. Accordingly, a friction stir welding tool may be used to join two vehicle parts together. During such welding operations, a component of the friction stir welding tool, such as a pin, may spin while in contact with a weld zone along a joint between the vehicle components to be welded. The pin may be moved along the joint while spinning, thus heating the material of the vehicle parts along the joint and intermixing them to form the weld. Moreover, during operation 402, an exit hole may be created. As similarly discussed above, the removal of the welding tool may create an exit hole at the end of the weld. In this way, weld operations may be performed to weld to vehicle parts together, and an exit hole may be formed as a result of such a weld.

Accordingly, method 400 may proceed to operation 404 during which a plug may be inserted into the exit hole created by the one or more weld operations. Accordingly, the repair tool may be configured such that a plug is mechanically coupled to a pin of the repair tool prior to insertion into the exit hole. Accordingly, a plug may be inserted or coupled to the repair tool by, for example, mounting a plug on a pin of the repair tool. The repair tool is further configured to position the pin and plug such that the plug is aligned with the exit hole and inserted into the exit hole. The repair tool may be configured to rotate or screw the repair plug into the exit hole until the plug is securely seated. Once secure in the exit hole, the mechanical coupling between the pin and the plug may be released, thus enabling the release of the plug once the plug has been positioned securely in the exit hole. For example, the plug may snap or shear off of the repair tool once securely seated. In various embodiments, the plug may be inserted by a separate tool, such as a drill, and the plug may snap or shear off when seated in the exit hole. In some embodiments, the plug is manually hammered into place and excess material of the plug may be cutoff such that the upper surface of the plug is flush with the upper surface of the vehicle parts. In this way, numerous techniques for insertion of the plug into the exit hole are disclosed herein.

Method 400 may proceed to operation 406 during which a pin associated with a repair tool may be adjusted. Accordingly, the pin included in the repair tool may be configured to implement repair operations. In some embodiments, the pin may be changed or replaced to one having a shape and geometry as described above with reference to the pin 102. Accordingly, a repair tool that was previously configured and used as a welding tool may be reconfigured again as a repair tool to implement repair operations. In various embodiments, the pin used for repair operations is different than the pin used for welding operations. For example, the pin used for welding operations may have a different diameter than the pin used for repair operations. More specifically, the pin used for welding operations may have a smaller diameter than the pin used for repair operations. In some embodiments, the pin used for welding operations may be configured to have a larger diameter than the pin used for repair operations if appropriate. In this way, during operation 406, the repair tool may be specifically configured to implement repair operations to repair the exit hole. In some embodiments, instead of adjusting a pin, a separate tool may be positioned and used. Accordingly, a first tool may be a welding tool used for welding operations, and a separate second tool may be a repair tool used for repair operations.

Method 400 may proceed to operation 408 during which a containment collar may be positioned around the exit hole and plug. Accordingly, during operation 408, the repair tool may be moved into a repair position associated with the exit hole in which the containment collar contacts surfaces of the welded vehicle parts, and surrounds the exit hole to bound an area and prevent the escape of plug material from within the bounded area. Accordingly, during operation 408, the positioning of the containment collar may create a seal between the repair tool and the vehicle parts.

Method 400 may proceed to operation 410 during which the pin may be positioned on the plug. As similarly discussed above, the pin may be extended such that a surface of the pin contacts an exposed surface of the plug, such as surface 209 discussed above. Furthermore, during operation 410, the shoulder member is also extended and positioned to contact surfaces of the vehicle parts, such as surfaces 211 and 213 discussed above. Accordingly, during operation 410 the pin and shoulder member may be positioned to enable the commencement of repair operations.

Method 400 may proceed to operation 412 during which the pin may be rotated to generate a frictional force. As discussed above, a spindle of the repair tool may generate a rotational force and transfer the rotational force to the pin causing it to rotate while in contact with the plug. In various embodiments, the rotating generates thermal energy based on a frictional force between the pin and the plug. Accordingly, friction between the surface of the pin and the surface of the plug generates heat which may cause the material of the plug to heat up, plasticize, and deform.

Method 400 may proceed to operation 414 during which pressure may be applied to the plug via the pin, and a position of the shoulder member may be adjusted. Accordingly, the repair tool may further extend the pin while continuing to rotate such that the pin is pushed into the exit hole. Pushing the pin into the exit hole in this way ensures that the heat generated by the rotation of the pin is applied to the entirety of the plug such that all of the plug is heated, as opposed to just the exposed surface. In some embodiments the pushing of the pin during operation 414 may cause the displacement of some of the plasticized material of the plug. Accordingly, a position of the shoulder member may be modified or adjusted to facilitate the movement of the material, and temporarily create a cavity into which the material may move to from the exit hole, thus facilitating the pushing of the pin into the exit hole. Once the pin has been pushed into the exit hole and heated the entirety of the plug, the pin may be retracted, and the position of the shoulder member may be adjusted again to facilitate the movement of the displaced plug material back into the exit hole. In some embodiments, such additional movement of the shoulder member may include applying an amount of pressure to the displaced plug material. Further details of these adjustments are described in FIGS. 6A-6E below.

Method 400 may proceed to operation 416 during which a material of the plasticized and deformed plug may be consumed and consolidated to fill the exit hole. As discussed above, the heat generated during operation 412 causes the material of the plug to plasticize and enter a state in which the material of the plug penetrates and fills contours of the exit hole and is able to intermix with materials of the vehicle parts. As also discussed above, as a result of the heating process and subsequent cooling off, the material of the plug may consolidate with the material of the one or more parts that were previously welded.

Method 400 may proceed to operation 418 during which the pin, the shoulder member, and the containment collar may be removed. Accordingly, the repair tool may move the containment collar, the pin, and the shoulder member to decouple them from the vehicle parts. In various embodiments, the repair tool may return to a resting position, or may move on to another exit hole if additional exit holes need repair.

While method 400 illustrates one example of a method of repairing an exit hole, other embodiments are contemplated and disclosed herein. Accordingly, while method 400 describes the positioning, rotation, and extension of a pin while shoulder member is retracted, such operations may be optionally performed or performed in a different order to implement variations of a method of repairing an exit hole. For example, a shoulder member may be positioned, rotated, and extended while the pin may be retracted. In this example, the rotation and extension of the shoulder member may cause the heating and consolidation of the plug, and the retraction of the pin may facilitate movement/displacement of the material and consolidation of the material throughout the exit hole.

FIGS. 5A-5C illustrate cross-sectional views of a plug being inserted into an exit hole, implemented in accordance with some embodiments. As shown in FIG. 5A, a pin, such as a pin 502 may be coupled to a plug, such as the plug 203. In some embodiments, the plug 203 may be mechanically coupled to the pin 502 via a coupler 504. For example, the coupler 504 may be a projection or a shaft which extends from the tip of the pin 502. The coupler 504 may fit inside a hole or indentation on the top of the plug 203, and may provide sufficient mechanical coupling to hold the plug 203 in place. As shown in FIG. 5A, the pin 502 and the plug 203 may be positioned such that they are aligned with an exit hole to be repaired, such as the exit hole 202 which has been formed as the result of welding operations associated with the first vehicle part 204 and the second vehicle part 206. In some embodiments, the pin 502 may be a different pin than the pin 102. Accordingly, different pins may be used for plug installation and consolidation respectively. In various embodiments, the same pin may be used for both operations. In such embodiments, the pin 502 may be the same as the pin 102.

As further shown in FIG. 5B, the pin 502 may be extended by a repair tool, such as the repair tool 100, to insert the plug 203 into the exit hole 202 by force or rotation or combination of each. As previously discussed, various different techniques may be implemented to insert the plug 203 into the exit hole 202. As illustrated in FIG. 5B, the plug 203 may be pushed into the exit hole 202 until secure mechanical coupling exists between the plug 203 and the exit hole 202. Furthermore, as additionally shown in FIG. 5C, the pin 502 may be retracted while the plug 203 is left in the exit hole 202. Accordingly, the secure fit between the plug 203 and the exit hole 202 provides greater mechanical coupling than the mechanical coupling between the coupler 504 and the plug 203, and as a result the plug 203 is detached from the coupler 504, and the plug 203 remains in the exit hole 202.

FIGS. 6A-6E illustrate cross-sectional views of an exit hole being repaired, implemented in accordance with some embodiments. As similarly discussed with reference to FIG. 2, FIG. 6A illustrates a repair tool that has been positioned adjacent to an exit hole that is being repaired, such as the exit hole 202. Accordingly, a containment collar, such as the containment collar 106, has been positioned in contact with surfaces of the vehicle parts 204 and 206, and has formed a seal around a bounded area that surrounds the exit hole 202. As further shown in FIG. 6B and as previously discussed with reference to at least FIG. 2, a pin, such as the pin 102, and a shoulder member, such as the shoulder member 104, may be extended such that contact surfaces of the vehicle parts 204 and 206, as well as the plug 203.

As additionally shown in FIG. 6C, the pin 102 may be rotated and pushed into the exit hole 202. As previously discussed, the rotation of the pin 102 may generate heat via frictional forces, and the generated heat may plasticize the material of the plug 203, and a position of the shoulder member 104 may be adjusted to facilitate movement of the plasticized material out of the exit hole 202. Accordingly, FIG. 6C illustrates an adjusted position of the shoulder member 104 after it has been retracted by a designated distance, as well as a material 602 that has been slightly displaced by the pin 102, and has been displaced into a cavity generated by the movement of the shoulder member 104. FIG. 6C further illustrates that thermal energy is provided to the entirety of the plug 203 as the pin 102 is pushed into the exit hole 202, and the pin 102 may, according to some embodiments, alter a shape and geometry of the exit hole 202 via plasticizing, deforming, and displacing surrounding material of the joint created between vehicle parts 204 and 206.

As shown in FIG. 6D, the positions of the pin 102 and the shoulder member 104 are returned to their initial position as the pin 102 is retracted, and the shoulder member 104 is extended. As illustrated in FIG. 6D, the material 602 has been pushed back into the vehicle parts 204 and 206 to create a consolidated region, such as a consolidated region 604. Accordingly, as shown in FIG. 6D, the exit hole 202 has been filled and repaired, and material of the plug 203 has consolidated with the vehicle parts 204 and 206. As shown in FIG. 6E, the repair tool 100 may be moved to remove and decouple the pin 102, the shoulder member 104, and the containment collar 106 from the vehicle parts 204 and 206 upon termination of the repair operations.

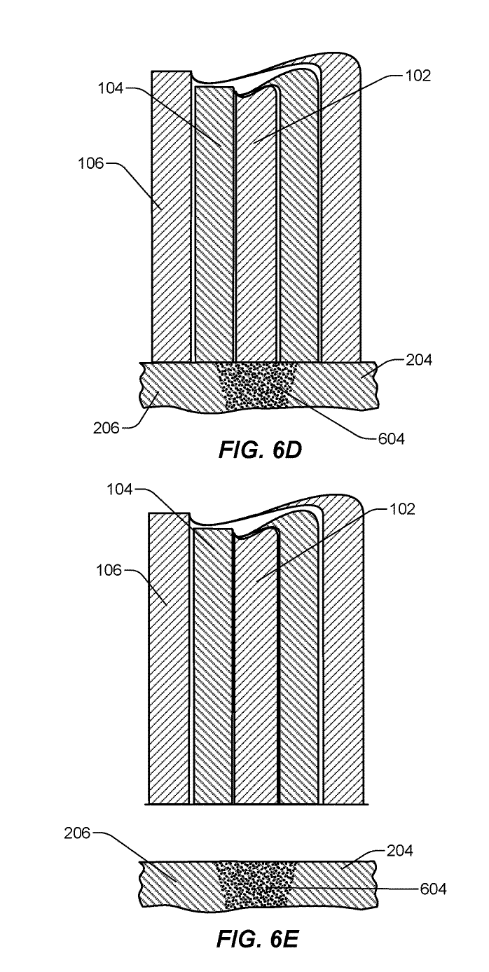

FIG. 7 illustrates an example of an external view of a repair tool, configured in accordance with some embodiments. As discussed above, a repair tool, such as the repair tool 100 and its various components, may be used to implement various repair operations. FIG. 7 provides an additional view of the containment collar 106, as well as the second coupling portion 110 associated with the shoulder member 104 and the first coupling portion 112 associated with the pin 102. Accordingly, FIG. 7 illustrates such coupling portions when detached from their associated spindles. Moreover, FIG. 7 illustrates the support member 118 coupled to components of the repair tool 100 at a lower position than that illustrated in FIG. 1. In this way, various configurations of support members may be implemented to provide structural support for the repair tool 100 and facilitate movement of the repair tool 100 to implement repair operations.

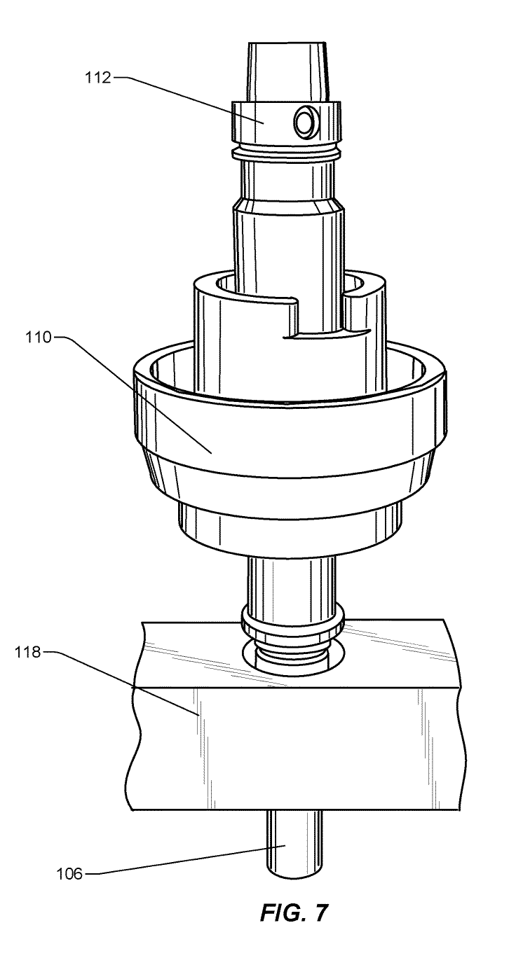

FIG. 8 illustrates a data processing system configured in accordance with some embodiments. The data processing system 800, also referred to herein as a computer system, may be used to implement one or more computers or processing devices used to control various components of devices and systems described above, as may occur during the implementation of repair operations. In some embodiments, the data processing system 800 includes a communications framework 802, which provides communications between a processor unit 804, a memory 806, a persistent storage 808, a communications unit 810, an input/output (I/O) unit 812, and a display 814. In this example, the communications framework 802 may take the form of a bus system.

A processor unit 804 serves to execute instructions for software that may be loaded into the memory 806. The processor unit 804 may be a number of processors, as may be included in a multi-processor core. In various embodiments, the processor unit 804 is specifically configured and optimized to process large amounts of data that may be involved when processing streaming data, as discussed above. Thus, the processor unit 804 may be an application specific processor that may be implemented as one or more application specific integrated circuits (ASICs) within a processing system. Such specific configuration of the processor unit 804 may provide increased efficiency when processing the large amounts of data involved with the previously described systems, devices, and methods. Moreover, in some embodiments, the processor unit 804 may be include one or more reprogrammable logic devices, such as field-programmable gate arrays (FPGAs), that may be programmed or specifically configured to optimally perform the previously described processing operations in the context of large and complex data sets.

The memory 806 and the persistent storage 808 are examples of storage devices 816. A storage device is any piece of hardware that is capable of storing information, such as, for example, without limitation, data, program code in functional form, and/or other suitable information either on a temporary basis and/or a permanent basis. The storage devices 816 may also be referred to as computer readable storage devices in these illustrative examples. The memory 806, in these examples, may be, for example, a random access memory or any other suitable volatile or non-volatile storage device. The persistent storage 808 may take various forms, depending on the particular implementation. For example, the persistent storage 808 may contain one or more components or devices. For example, the persistent storage 808 may be a hard drive, a flash memory, a rewritable optical disk, a rewritable magnetic tape, or some combination of the above. The media used by the persistent storage 808 also may be removable. For example, a removable hard drive may be used for the persistent storage 808.

The communications unit 810, in these illustrative examples, provides for communications with other data processing systems or devices. In these illustrative examples, the communications unit 810 is a network interface card.

The input/output unit 812 allows for input and output of data with other devices that may be connected to the data processing system 800. For example, the input/output unit 812 may provide a connection for user input through a keyboard, a mouse, and/or some other suitable input device. Further, the input/output unit 812 may send output to a printer. The display 814 provides a mechanism to display information to a user.

Instructions for the operating system, applications, and/or programs may be located in the storage devices 816, which are in communication with the processor unit 804 through the communications framework 802. The processes of the different embodiments may be performed by the processor unit 804 using computer-implemented instructions, which may be located in a memory, such as the memory 806.

These instructions are referred to as program code, computer usable program code, or computer readable program code that may be read and executed by a processor in the processor unit 804. The program code in the different embodiments may be embodied on different physical or computer readable storage media, such as the memory 806 or the persistent storage 808.

The program code 818 is located in a functional form on a computer readable media 820 that is selectively removable and may be loaded onto or transferred to the data processing system 800 for execution by the processor unit 804. The program code 818 and the computer readable media 820 form the computer program product 822 in these illustrative examples. In one example, the computer readable media 820 may be a computer readable storage media 824 or a computer readable signal media 826.

In these illustrative examples, the computer readable storage media 824 is a physical or tangible storage device used to store the program code 818 rather than a medium that propagates or transmits the program code 818.

Alternatively, the program code 818 may be transferred to the data processing system 800 using the computer readable signal media 826. The computer readable signal media 826 may be, for example, a propagated data signal containing the program code 818. For example, the computer readable signal media 826 may be an electromagnetic signal, an optical signal, and/or any other suitable type of signal. These signals may be transmitted over communications links, such as wireless communications links, optical fiber cable, coaxial cable, a wire, and/or any other suitable type of communications link.

The different components illustrated for the data processing system 800 are not meant to provide architectural limitations to the manner in which different embodiments may be implemented. The different illustrative embodiments may be implemented in a data processing system including components in addition to and/or in place of those illustrated for the data processing system 800. Other components shown in FIG. 8 can be varied from the illustrative examples shown. The different embodiments may be implemented using any hardware device or system capable of running the program code 818.

While the systems, apparatus, and methods disclosed above have been described with reference to airplanes and the aerospace industry, it will be appreciated that the embodiments disclosed herein may be applied to any other context as well, such as automotive, railroad, and other mechanical and vehicular contexts.

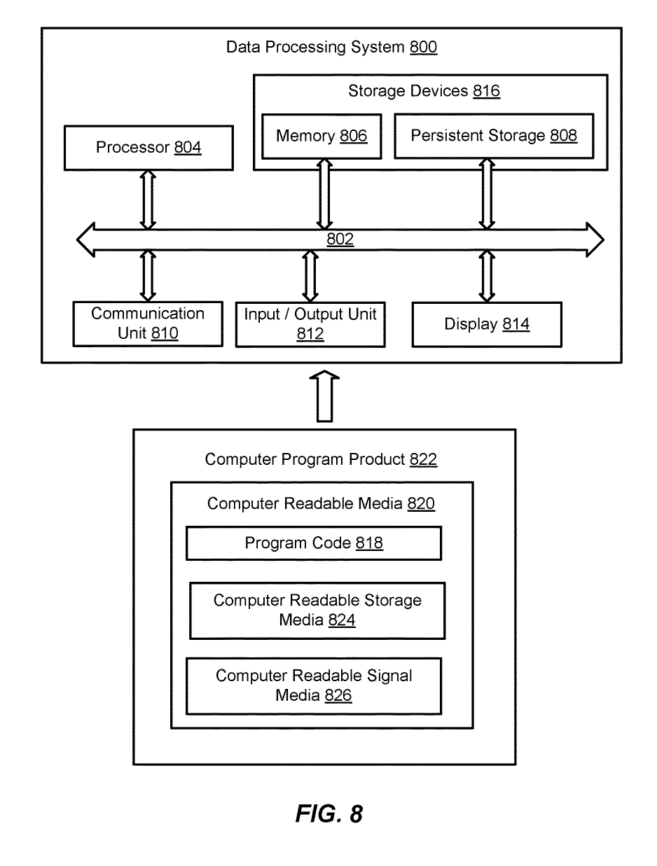

Accordingly, embodiments of the disclosure may be described in the context of an airplane manufacturing and service method 900 as shown in FIG. 9 and an airplane 902 as shown in FIG. 9. During pre-production, illustrative method 900 may include the specification and design 904 of the airplane 902 and material procurement 906. During production, component and subassembly manufacturing 908 and system integration 910 of the airplane 902 takes place. Thereafter, the airplane 902 may go through certification and delivery 912 in order to be placed in service 914. While in service by a customer, the airplane 902 is scheduled for routine maintenance and service 916 (which may also include modification, reconfiguration, refurbishment, and so on).

Each of the processes of method 900 may be performed or carried out by a system integrator, a third party, and/or an operator (e.g., a customer). For the purposes of this description, a system integrator may include without limitation any number of airplane manufacturers and major-system subcontractors; a third party may include without limitation any number of venders, subcontractors, and suppliers; and an operator may be an airline, leasing company, military entity, service organization, and so on.

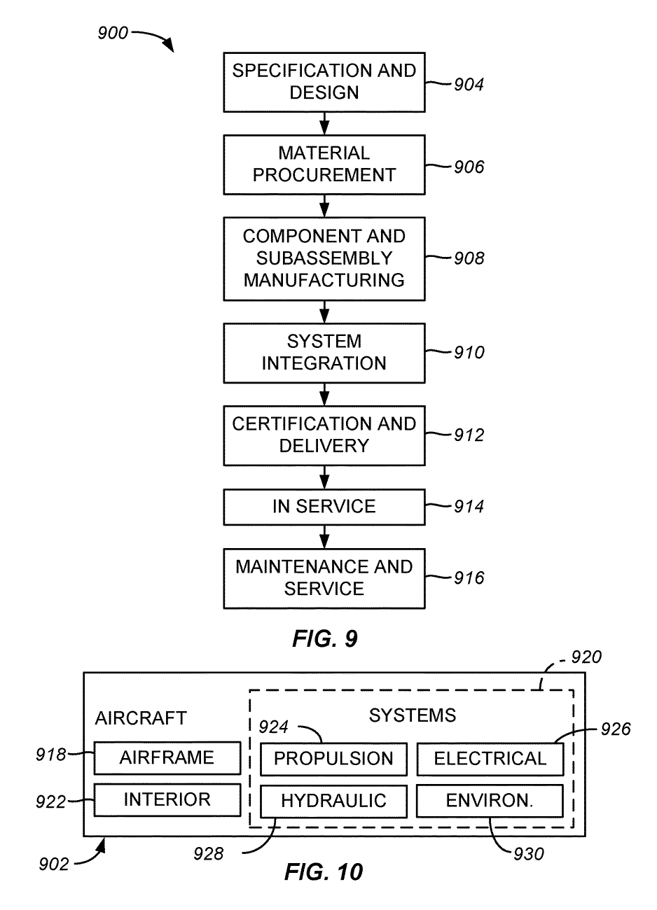

As shown in FIG. 10, the airplane 902 produced by illustrative method 900 may include an airframe 918 with a plurality of systems 920, and an interior 922. Examples of high-level systems 920 include one or more of a propulsion system 924, an electrical system 926, a hydraulic system 928, and an environmental system 930. Any number of other systems may be included. Although an aerospace example is shown, the principles of the embodiments disclosed herein may be applied to other industries, such as the automotive industry.

Apparatus and methods embodied herein may be employed during any one or more of the stages of the production and service method 800. For example, components or subassemblies corresponding to production process 808 may be fabricated or manufactured in a manner similar to components or subassemblies produced while the airplane 802 is in service. Also, one or more apparatus embodiments, method embodiments, or a combination thereof may be utilized during the production stages 808 and 810, for example, by substantially expediting assembly of or reducing the cost of an airplane 802. Similarly, one or more of apparatus embodiments, method embodiments, or a combination thereof may be utilized while the airplane 802 is in service, for example and without limitation, to maintenance and service 816.

Although the foregoing concepts have been described in some detail for purposes of clarity of understanding, it will be apparent that certain changes and modifications may be practiced within the scope of the appended claims. It should be noted that there are many alternative ways of implementing the processes, systems, and apparatus. Accordingly, the present examples are to be considered as illustrative and not restrictive.

What is claimed is:

1. A method of filling an exit hole created by a welding operation, the method comprising:
inserting a plug into the exit hole in one or more vehicle parts, the exit hole created by the welding operation performed on the one or more vehicle parts;
positioning a first pin on the plug such that the first pin is contacting an exposed surface of the plug;
rotating the first pin while contacting the exposed surface of the plug, the rotating generating thermal energy based on a frictional force associated with the first pin and the plug; and
filling the exit hole by heating and plasticizing the plug via the thermal energy, and consolidating a material of the plug with the one or more vehicle parts.

2. The method of claim 1, wherein the first pin is positioned approximately normal to the exposed surface of the plug.

3. The method of claim 2, wherein the exposed surface of the plug is an upper surface of the plug.

4. The method of claim 1, wherein the rotating of the first pin and the filling of the exit hole further comprise:
applying pressure to the exposed surface of the plug via the first pin;
plasticizing the material of the plug via the thermal energy;
extending, while rotating, the first pin into the exit hole;
mixing the material of the plug; and
retracting the first pin from the exit hole.

5. The method of claim 4, wherein the plug is consumed by consolidation with the one or more vehicle parts.

6. The method of claim 1, wherein the exit hole is created by a friction stir welding operation performed on a portion of a joint.

7. The method of claim 6, wherein the joint is a butt joint between a first vehicle part and a second vehicle part.

8. The method of claim 7, wherein the friction stir welding operation is performed using a second pin.

9. The method of claim 8, wherein the second pin has a different diameter than the first pin.

10. The method of claim 9, wherein the second pin has a smaller diameter than the first pin.

11. A device for filling an exit hole created by a welding operation, the device comprising:
a containment collar configured to contact a plurality of surfaces of a plurality of vehicle parts associated with the welding operation, and further configured to form a seal around the exit hole;
a pin configured to be positioned on a plug inserted in the exit hole, and further configured to be rotated while in contact with an exposed surface of the plug; and
a shoulder member configured to facilitate a movement of a material of the plug during an extension of the pin.

12. The device of claim 11, wherein the pin is configured to be retractable in a first direction and extendable in a second direction, and wherein the pin is further configured to apply pressure to the exposed surface of the plug while the pin is rotating.

13. The device of claim 12, wherein the rotating generates thermal energy based on a frictional force associated with the pin and the plug.

14. The device of claim 13, wherein heating of the plug via the thermal energy and plasticizing causes consolidation of a material of the plug with the plurality of vehicle parts and further causes the filling of the exit hole.

15. The device of claim 14, wherein the shoulder member is configured to be retractable in the first direction and extendable in the second direction, wherein the shoulder member is configured to generate a cavity into which at least some of the material of the plug enters when the shoulder member is retracted in the first direction, and wherein the shoulder member is configured to apply an amount of pressure to the material of the plug when extended in the second direction.

16. A system for filling an exit hole created by a welding operation, the system comprising:
at least one spindle configured to generate a rotational force; and
a repair tool comprising:
a containment collar configured to contact a plurality of surfaces of the plurality of vehicle parts, and further configured to form a seal around the exit hole;
a first pin configured to be positioned on a plug inserted in the exit hole, and further configured to be rotated while in contact with an exposed surface of the plug; and
a shoulder member configured to facilitate a movement of a material of the plug during an extension of the first pin.

17. The system of claim 16, wherein the first pin is configured to be retractable in a first direction and extendable in a second direction, wherein the first pin is further configured to apply pressure to the exposed surface of the plug while the first pin is rotating, wherein the rotating generates thermal energy based on a frictional force associated with the first pin and the plug, and wherein heating of the plug via the thermal energy and plastic deformation causes consolidation of a material of the plug with the plurality of vehicle parts and further causes the filling of the exit hole.

18. The system of claim 17, wherein the shoulder member is configured to be retractable in the first direction and extendable in the second direction, wherein the shoulder member is configured to generate a cavity into which at least some of the material of the plug enters when the shoulder member is retracted in the first direction, and wherein the shoulder member is configured to apply an amount of pressure to the material of the plug when extended in the second direction.

19. The system of claim 18, wherein the welding tool comprises:
a second pin configured to be rotated, and further configured to friction stir weld the joint associated with a plurality of vehicle parts.

20. The system of claim 19, wherein the second pin has a smaller diameter than the first pin.
